(19) United States
(12) Patent Application Publication
(10) Pub. No.: US 2008/0248283 A1
(43) Pub. Date: Oct. 9, 2008

(54) Expanded polymer material for cryogenic applications apparatus and method

(76) Inventors: Thomas M. Golner, Pewaukee, WI (US); Shirish P. Mehta, Waukesha, WI (US); Edward F. Pleva, Waukesha, WI (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/783,104

(22) Filed: Apr. 5, 2007

(51) Int. Cl. B32B 5/22; B29C 44/58; B29C 67/00

(52) U.S. Cl. 428/317.9; 264/46.4; 425/4 R

(57) ABSTRACT

A structural and insulating material for cryogenic power transformers uses nonwoven fibers, such as polyester matting, embedded within epoxy made highly porous with a blowing agent. The open cell foam of the material is characterized by controlled pore size and density, tolerance of extreme thermal gradients, and strength at cryogenic temperatures, and is selected for compatibility with dielectric fluids such as liquid nitrogen and cryogenic blends.

### FIELD OF THE INVENTION

The present invention relates generally to structural materials for cryogenic applications. More particularly, the invention relates to apparatus and methods for providing reinforced, expanded polymer structural materials suitable for application to high-voltage, high-current, cryogenic, superconducting electrical equipment.

### BACKGROUND OF THE INVENTION

Cryogenic superconducting power apparatus requires novel materials to accommodate the combination of high voltage, high current, high magnetic field flux density, mechanical stress, and temperatures substantially colder than those for which ordinary materials are typically characterized. Some materials for superconducting power transformers and related devices have been developed and publicized, including superconducting wire, compatible core materials, and cryogenic coolant fluids, but some components are only now achieving full characterization. Among these are replacements for the cellulose-based paper and composite board materials commonly used as insulating spacers in non-superconducting transformers.

Moreover, the minimal self-support capability that characterizes foreseeable superconducting wire materials establishes a need for new categories of structural materials to provide support within superconductor transformer housings. Unlike cores, outer enclosures, cooling apparatus, load tap changers, and high-voltage insulators, such structural support materials do not have direct analogs in non-superconducting power electronics. Such materials further require, to the extent possible, cost effectiveness as determined by use of known constituents, ease and speed of fabrication, and serviceability over an indefinite lifetime.

Some previous attempts to form structural members for cryogenic power applications included manufacture of non-foamed fiber-reinforced epoxy structures. In such attempts, it became evident that some occurrence of embedded defects was inevitable despite stringent efforts to achieve uniformity. The defects, including local failures to wet the layered solid material, variations in epoxy polymerization chain length uniformity, and others, tended to permit voids and delaminations. The voids, in particular, formed trapped and substantially encapsulated gas pockets with lower dielectric constant than the surrounding bulk materials. Such defects became evident at least during evaluation. Undesirable properties included cracking during cryogenic cooldown or when subjected to the severe thermal gradients endemic in cryogenic power apparatus, local electrical leakage producing hot spots, breakdowns, and the like, inability to retain strength during or recover from mechanical deflection, and other flaws.

U.S. Pat. No. 6,271,463 to Kultzow et al. (hereinafter Kultzow), entitled Use of Expandable Epoxy Systems for Barrier Materials in High Voltage Liquid Filled Transformers, is herein incorporated by reference. In a fabrication procedure described in Kultzow, multiple mats of so-called polyester veil material are laid up in a two-part mold, a first portion of blended epoxy resin, hardener, and a blowing agent is poured and spread over the mat stack, the wetted stack is then flipped over to contact the bottom face of the mold, a second portion of the epoxy is poured and spread over this surface, a second and final mat stack is laid atop this, a third and final portion of the epoxy is poured and spread, the top of the mold is fitted in place and pressed closed, compressing the mass, and the assembly is subjected to a controlled curing temperature sequence.

The process of Kutzlow produces a porous barrier material for use in a normal-temperature power transformer that operates at roughly 300-400 degrees Kelvin, filled with some form of mineral oil, and serving as a replacement for a prior-art cellulosic pressed fiber material—essentially paper or pressboard. The material of Kutzlow exhibits some superior properties compared to paper. Since paper barrier material has minimal structural requirements, structural attributes of the replacement material were considered minimally in Kutzlow. Similarly, since both the paper material and the material of Kutzlow were intended for warm applications that are relatively thermally uniform, cryogenic and thermal gradient properties are not addressed in Kutzlow.

Materials for use in superconducting power equipment environments are subjected to substantially all of the mechanical and electrical stresses of warm-equipment materials, including at least those noted above. Materials for superconductor applications preferably have desirable and quantifiable performance regarding dielectric constant, dissipation factor, magnetic permeability and related properties, chemical compatibility with preferred cryofluids, stability and freedom from loss of mass over time, pressure, vacuum, and chemical attack within the indicated working environment, thermal transient and thermal gradient tolerance, retention of structural strength and resilience over extreme temperature range, controllable uniformity and gradability of properties, freedom from defects affecting performance, and manufacturability.

### SUMMARY OF THE INVENTION

The above disadvantages have been overcome to at least some degree by a novel cryogenic material, as herein described.

In accordance with one embodiment of the present invention, a porous structural material for immersion in a dielectric cryogenic fluid is provided. The structural material includes a matrix of fibers comprising a first organic polymer, wherein the fibers are compatible with being subjected to power transmission field gradients in a cryogenic environment, an epoxy that wets the fiber matrix substantially completely, and that forms a second organic polymer in the course of a curing process, wherein the epoxy is compatible with being subjected to power transmission field gradients in a cryogenic environment, and an interconnected pore structure within the epoxy, wherein a blowing agent establishes the pore structure within the epoxy-wetted fiber matrix as a part of the curing process, and wherein the pore structure allows a specified extent of flow of a cryogenic fluid through a porous composite cryogenic structural material established by the curing process.

In accordance with another embodiment of the present invention, apparatus for producing porous structural material for immersion in a dielectric cryogenic fluid is provided. The apparatus includes a mold configured to constrain constituents to a defined shape during formation of a cryogenic structural component, at least one mold inlet port configured to admit a hardenable fluid constituent, comprising a blowing agent, into the mold cavity, wherein the hardenable fluid constituent is compatible with exposure to cryogenic fluids and temperatures after hardening, injection apparatus configured to urge the hardenable fluid constituent into the mold cavity, at least one outlet port configured to vent the mold cavity during at least one of filling the mold cavity with the hardenable fluid constituent, forming interconnected pores within the hardenable fluid constituent by a blowing gas released from the blowing agent, and curing of the hardenable fluid constituent at least in part within the mold, and an environmental regulator configured to provide a specified extent of control over at least one of temperature and pressure within the mold cavity.

In accordance with still another embodiment of the present invention, a porous structural material for immersion in a dielectric cryogenic fluid is provided. The embodiment includes means for providing mechanical strength to a cryogenic structural material, means for binding the means for providing mechanical strength into a solid mass, wherein the means for binding is compatible with exposure to cryogenic stresses, and means for introducing a matrix of interconnected pores within the means for binding.

In accordance with yet another embodiment of the present invention, a process for forming a porous structural material for immersion in a dielectric cryogenic fluid is provided. The process includes placing at least one precut mat of nonwoven fibers within a mold, closing the mold to an extent sufficient to define a specific interior volume and shape, and to seal the mold against uncontrolled outflow of fluids, injecting an epoxy mixture that includes a blowing agent into the mold through at least one mold inlet port, venting gases from the cavity through at least one outlet port, and regulating mold temperature and pressure throughout a cryogenic structural material forming process to an extent sufficient to ensure wetting the fibers, curing the epoxy at least in part, and forming interconnected pores with a specified distribution throughout a finished cryogenic structural material compatible with immersion and saturation in a cryogenic dielectric fluid.

There have thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology herein, as well as in the abstract, are employed for the purpose of description and should not be regarded as limiting.

As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective section view of a cryogenic structural component according to the instant invention.

FIG. 2 is a section view of a mold for forming a structural component in accordance with FIG. 1.

FIG. 3 is a perspective view of a representative mold for forming a curved structural component for use in a cryogenic power transformer or associated apparatus.

FIG. 4 is a process flow diagram showing a sequence of steps for producing a cryo-compatible structural component.

### DETAILED DESCRIPTION OF THE INVENTION

In accordance with the present invention, a structural material compatible with forming components for operation within cryogenic power transformers and related cryogenic electrical equipment, and apparatus and method for providing such materials and components, are disclosed. The apparatus and method provide materials having significant structural strength at cryogenic temperatures. Components formed of such materials can be made to be compatible with service over broad temperature swings and gradients and high electric field gradients, such as those generated at least by high-power, low frequency alternating current.

It is to be understood that at least some cryogenic transformer applications include transformer windings that superconduct only below specified cryogenic temperatures, and include transformer cores that are not effective at cryogenic temperatures. In order to maintain such incompatible temperature regimes in close proximity, structural components interposed between core and windings, for example, may have large temperature gradients across them, while simultaneously being subjected to substantial voltage gradients and magnetic fluxes. Since representative superconductor winding materials may be mechanically weak, specifically in comparison to copper or other non-superconducting winding materials intended for warm temperature use, structural components for superconductor transformer application require mechanical strength and stability beyond that afforded by typical warm transformer barrier materials.

It is to be further understood that the mineral oils and comparable dielectric fluids used as insulating and heat transfer media in warm transformers are solid or broken down at cryogenic temperatures and are thus unsuitable for superconducting applications. Representative cryogenic transformer dielectric fill fluids that correspond to transformer oils but are suitable for cryogenic applications may include liquid nitrogen, other cryogenic liquids, such as the “noble” or “permanent” gases (argon, neon, etc.), or blends thereof. Other environments within superconducting power apparatus may include exposure to vacuum.

The invention will now be described with particular reference to the drawing figures, in which like reference numerals refer to like parts throughout.

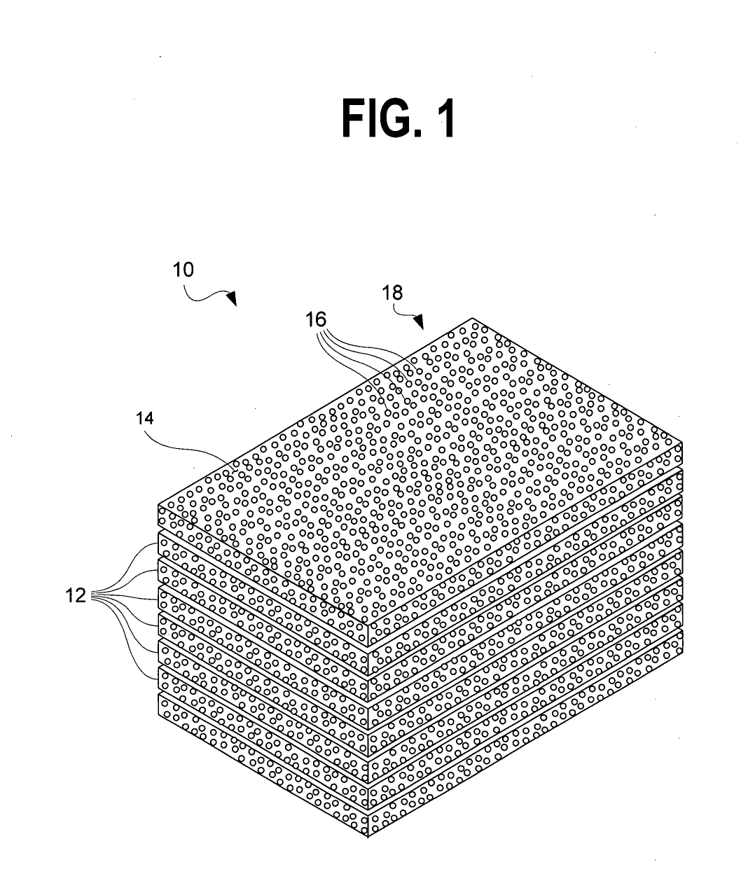

FIG. 1 shows a fragment of a structural member 10 of a design compatible with inclusion within a cryogenic electrical power transformer. In the specific embodiment shown in FIG. 1, the member 10 has a plurality of layers, herein termed mats 12, with each mat 12 being formed from a suitable organic polymer fiber material, and with the mats 12 surrounded by and infused with a substantially uniform epoxy material 14. The fibers, as infused with the epoxy material 14, effectively form a structural matrix that is largely continuous within and between the layers, as each mat 12 is a multitude of largely random fibers bonded together to a variable extent during formation of the mat 12, while the epoxy material 14 forms an overall bond between the fibers, limited by the extent of wetting of the fibers and the adhesive and cohesive strength of the organic polymer making up the epoxy. Within the epoxy material 14 are multiple pores 16 formed during the setup and cure of the epoxy material 14. The pores 16, shown schematically as round and closed, are actually in communication to a great extent, and establish an overall material that is a fiber reinforced open-celled foam, so that the member 10 is capable of allowing a cryogenic fluid 18 in which the member 10 is immersed to flow through as well as around the member 10.

Viewed in another way, the material 10 is a fibrous construct of a first organic polymer, wherein the fibers 12 are coated with a second organic polymer 14 that forms a largely continuous surface over the fibers 12 of the first polymer, bonding the fibers 12 into a strong, nonconductive whole with extensive and communicating voids 16 between the coated fibers. The construct may be capable of sustaining flexure without a significant extent of fracture and of performing structural and insulating functions at cryogenic temperatures.

Successful introduction of a blowing agent to the epoxy mix causes “defects” observed in earlier attempts at cryogenic structural material production to become widely and substantially uniformly distributed, then connected and vented as bubbles or cells within a foam; joining of the cells through breakage of cell walls forms an overall structure that allows passage of the cryogenic fill fluid. This gives the as-formed material of the member 10 the needed homogeneity and freedom from the entrapped gas pockets observed in non-foamed materials. Moreover, since the dielectric constants of the fill fluid and the structural material can be adjusted to be similar, a need for uniformity of pore density, for example, may be reduced. Tailoring dimensions and properties of the member 10 to accommodate a porous internal structure can be straightforward in at least some embodiments.

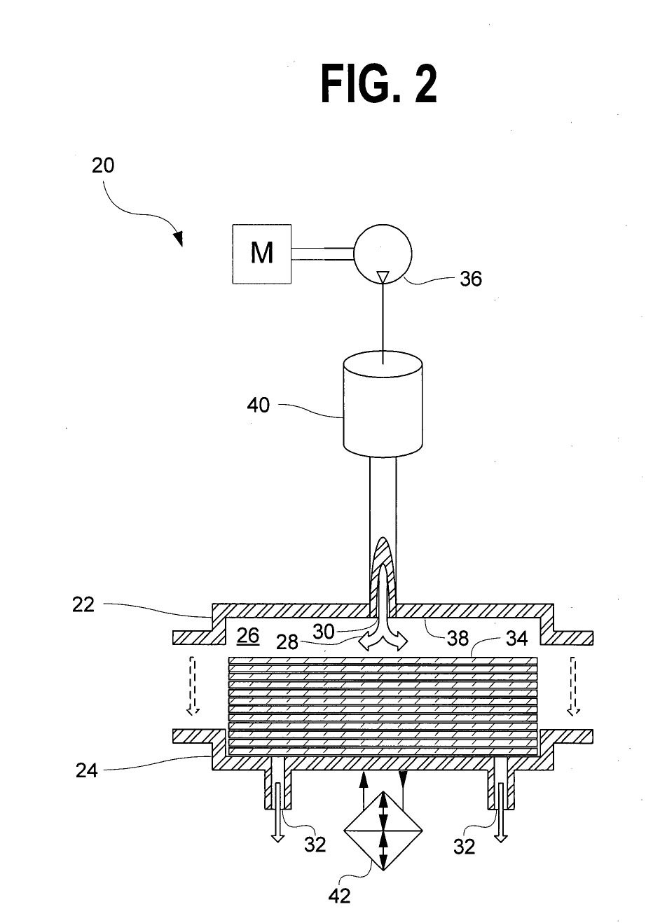

FIG. 2 shows in schematic form a cross section of a mold 20 generally suited for use in making a structural component incorporating the inventive apparatus and method. The mold 20, shown open, has an upper half 22 and a lower half 24; this basic arrangement may apply in some embodiments, although in others the mold 20 may be assembled from more pieces, observe mold-design rules for relief angles, etc. The mold 20 provides an internal chamber 26 that accepts a liquid epoxy 28 formulated from resin, hardener, and blowing agent constituents, as well as such other conditioning agents (plasticizers, flow promoters, wetting agents, and the like) as may be appropriate for a specific application. The epoxy 28 is introduced from a reservoir 40 through at least one inlet port 30. In typical embodiments, a plurality of outlet ports 32 allows flow from the inlet port 30 to proceed through substantially all interstices of the mats 34, displacing air from the mold 20 as flow pressure from an injector pump 36 or equivalent source urges the epoxy 28 throughout. A thermal regulator 42, capable of at least one of heating, cooling, sensing, and controlling temperature, may be desirable in some embodiments.

For some embodiments, the epoxy formulation may be selected so that the epoxy cures to form a substantially rigid plug at each of the outlet ports 32 as the flow reaches the ports; such a combination of materials and layout can minimize leakage and required total mix volume without necessitating liquid-blocking barriers on the outlet ports 32. In other embodiments, pressure regulation, realized using the injector pump 36 or another device, in conjunction with pressure valves or auxiliary pressure or vacuum sources on the outlet ports 32, may maintain pressure within the mold 20 at a specified level or sequence of levels during curing, thereby serving as a regulating factor for fiber wetting, pore size, pore distribution, or pore interconnection.

As noted above, use of a blowing agent within an epoxy mix is known for other applications, and is described at least in Kultzow. Typical blowing agents react to another constituent of the epoxy mixture. For example, at least some of the blowing agents cited in Kultzow evolve hydrogen gas in reaction to the presence of amine groups in the epoxy resin. Other blowing agents may use a variety of trigger chemicals, may be instead activated thermally or by another process, and may evolve any of a variety of gases. The open-cell structure of the instant invention implies that the evolved gas will be vented to a great extent rather than encapsulated within the finished product; the gas may be chosen to be substantially harmless, to the extent practical. As a corollary to this, because the gas evolved from the blowing agent is ultimately intended to be displaced virtually entirely, little risk is incurred in some embodiments if the blowing gas is not optimized for compatibility with the final product materials and with the cryogenic working temperature range. Numerous alternative foaming technologies are known and may be applicable in at least some embodiments.

In some embodiments, it may be preferable to apply vacuum, dry nitrogen at pressure, thermal soak at a specified temperature, or another conditioning treatment to the mold 20 prior to introduction of the liquid epoxy mixture. Such steps may serve to prepare the mold, remove free or adsorbed impurities such as reactive gases that may be present in workshop air, improve process quality or uniformity, or the like. It may be further appropriate in at least some embodiments to apply a mold release agent to the inner surface 38 of the mold 20 to promote disassembly and removal of the cured component. In other embodiments, a mold release agent that is combined into the epoxy mixture and migrates readily to the mold-to-component boundary may provide satisfactory utility, while in still other embodiments the epoxy mixture and at least the surfaces of the mold contacting the epoxy may be intrinsically nonadhesive to one another.

The component as removed from the mold may have a reduced surface porosity—a skin—compared to the bulk of the component material. In some embodiments, it may be preferred to remove the outer skin of the component by abrading, sawing, sandblasting, chemical etching, or a like process in order to establish final properties. In other embodiments, the component as formed may be a bulk material or a rough shape to be cut up, machined into final form, or the like.

It is to be understood that the embodiment shown in FIG. 1 includes layered mats 12 in the form of fibers of a suitable organic polymer material, with the fibers of the individual layers random in orientation to some extent, and typically bonded. Felting, thermal bonding, chemical or radiation cross-linking, mat formation during polymerization, and other methods may be used in at least some embodiments in gathering the fibers into relatively thin, flat, nonwoven mats 12 having generally random fiber orientation and at least some mechanical integrity. In other embodiments, woven or knitted materials may be used; such materials may provide greater control over uniformity of strength and dimensional stability with orientation (isotropy), such as by adjusting fiber gauge, strand spacing by axis, tension, or other fabric manufacture variables, traded against potential process changes. In still other embodiments, nonwoven organic polymer fibers may be more or less loose with respect to one another (bulk fibers), or may be in the form of a single thick layer that fills the mold rather than the multiple thin layers shown. The last of these has been shown to produce more rigid, less compliant structures, compatible with some cryogenic applications, and distinguished in part by size; bulk fibers may be suitable for deck-of-cards-sized components such as brackets, for example, but less suitable for card-table-sized components such as panels.

In yet other embodiments, fibers such as polyesters or nonfibrous divided solids such as talc may be blended into the epoxy material as filler and introduced either into a substantially empty mold or into the fiber-loaded mold 20 shown in FIG. 2. The use of blended filler may require attention to flow properties of the combined material rather than or in addition to the flow and wetting properties of the epoxy with respect to the preloaded, and largely static, fibers. Employing filler may potentially dictate altering port geometry as well as adjusting viscosity and curing rate of the blended material. Since filler fibers are chopped into short lengths in many embodiments, physical and electrical characteristics of the finished material, such as beam and compression strength, dielectric uniformity, and the like, must likewise be considered in the context of filled epoxy. Flow properties of epoxy that includes filler may affect isotropy and strength uniformity of the member 10. As in the decision matrix for layered versus nonlayered versus woven or knitted fibers, suitability of using any type of filler is a function of the final properties required.

Multiple forms of fiber, such as bulk, nonwoven layers, and woven layers, as well as fiber and nonfiber filler, may be combined in a single member 10 in some embodiments.

Structural materials according to the instant invention retain the flexibility of the unbonded fiber in part. The foamed epoxy has relatively thin individual segments, so that the finished materials tend not to accumulate internal stresses and faults during fabrication, unlike materials formed from nonfoamed fiber reinforced epoxies. Under mechanical and thermal stress, the materials tend not to crack or distort, but to yield elastically, and to recover their original dimensions when the stress is removed. Urging a second hardening liquid such as a low-viscosity epoxy or like material into the interstices of a fully-cured structure tends to provide greater strength along with rigidity. This may be desirable for structural materials intended for use in vacuum chambers or like environments within cryogenic apparatus.

Apparatus for vacuum or high-purity fluid applications may require low-outgassing structural materials. Structural materials fabricated according to the instant invention have short mean migration paths for embedded gas molecules (water, air, epoxy monomers, and the like). As a consequence, vacuum conditioning for such materials may be more rapid than for nonfoamed materials.

Representative fiber types include polyesters and other organic polymers that wet well with the organic polymers of representative epoxies, and that exhibit desirable combined properties at cryogenic temperatures. Aramids, polyamides, polyethylene terephthalate, polyphenylene sulfide, liquid crystal polymers, acrylics, and other polymers may be comparable or superior to polyesters for specific embodiments. Selection criteria for a specific fiber or combination of fibers include cryogenic temperature behavior, electrical properties, and compatibility with specific resin, hardener, blowing agent residue, and fill fluid (liquid nitrogen and other condensates).

Conductive fiber such as carbon or metal is broadly viewed as unsuitable for applications calling for dielectric (typically as nonconductive as possible) cryogenic structural members. However, carbon fiber may be suitable for some uses, particularly where maximum strength over temperature is required and where the intrinsic moderate conductivity of the fiber component of the structural member does not positively exclude its use.

Returning to FIG. 2, the mats 34 are readily cut to size and stacked in the mold 20 to a desired thickness. The mat-loaded mold 20 is then assembled and pressed shut; in the embodiment shown, the relaxed mats 12 may form a stack approximately twice as tall as the height of the mold chamber 26, and thus of the finished component. Once the mold 20 is closed and the temperature adjusted, the epoxy mixture 28 is introduced to flow around and wet the fibers of the mats 34, with the resin, hardener, and blowing agent reacting to form the final material and introduce open-cell pores according to the formulation and temperature selected.

In some embodiments, the combined wet materials may be introduced at a reduced temperature or pressure, so that wetting of the fibers occurs largely prior to application of energy to initialize the curing and blowing process. In other embodiments, curing may include an electron beam or X-ray process, wherein ionizing radiation penetrating a suitable mold 20 initiates or drives polymerization of the epoxy and/or causes the blowing agent to release the pore-forming gas. Still other embodiments may use prepreg fiber mat materials, with the epoxy and/or blowing agent introduced onto the mats 12 in a nonreactive form prior to loading the mold 20, then activated by a process such as temperature or pressure change, radiation, introduction of a triggering or catalyzing gas, or the like.

Temperature control may include heating, cooling, or providing a profile combining the two during storage, mixing, injection, and/or curing, as typical epoxies are temperature sensitive and are exothermic during cure, and regulation of rates of cure and blowing agent gas evolution may achieve particular product properties. In other embodiments, the process may be broadly insensitive to environmental conditions, so that provision of heating or cooling capability may not be required.

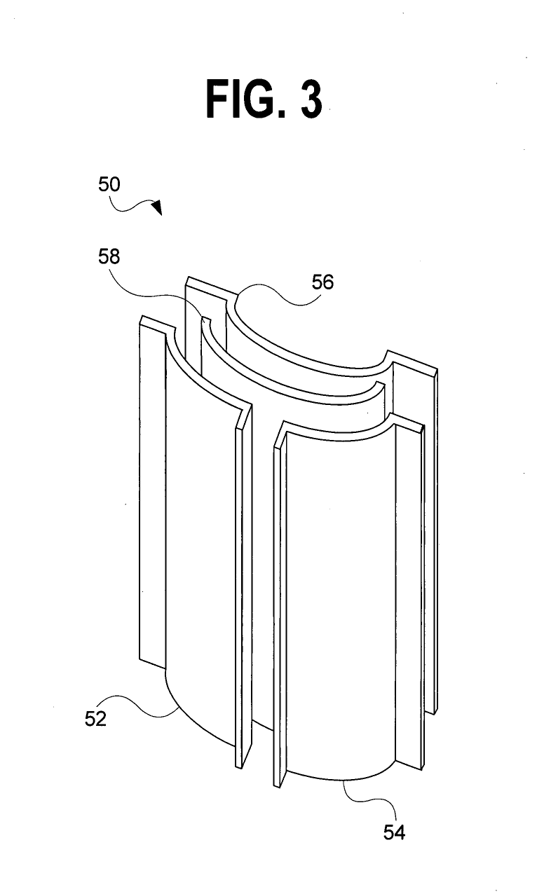

FIG. 3 shows an arcuate embodiment 50 as an exploded multipart mold 52, 54, and 56 within which a half of a curved shell component 58 built up from multiple layers of mat material as discussed above has been formed. As in those of the previous figures, layers of fiber are preloaded or compressed in one direction—radially in this embodiment—generally along the axis of compression of a felting or pressure bonding process previously used for forming the individual fiber layers. In other embodiments, preload compression prior to epoxy injection may be applied in multiple directions, or the compression may be on an axis other than the felting axis. If fibers are introduced into the epoxy as filler and the mixture is injected into a mold lacking a fiber prefill, compression may be negligible or effectively omnidirectional.

Pore concentration in typical members fabricated according to the inventive process may be on the order of twenty percent by volume, with fiber concentration also around twenty percent and epoxy concentration around sixty percent. Pore concentration range for applications known to be relevant to cryogenic transformers is roughly 15% to 30% by volume; fiber concentration in such applications is roughly 15% to 50%, while epoxy-plus-additional-materials concentration is roughly 30% to 70%. Since epoxy and polyester fiber have similar specific gravities, mass percentages and volume percentages are broadly comparable, and are used interchangeably herein.

In forming thin-wall panels or other shapes (i.e., flat, curved, or plural-surface structures with at least one relatively small dimension), it is to be noted that thickness is preferably related to pore density and to pore size in achieving satisfactory finished products. In a first example, in a relatively thin panel, it has been shown to be appropriate to adjust epoxy formulation (viscosity, curing rate, and the like), blowing agent properties (concentration, gas type, reaction rate, and the like), mold temperature profile, and like parameters to provide comparatively large and profuse pores. This ensures that the pores will join and open during formation of the panel, which in turn allows well-distributed penetration and flow of fill fluid within a transformer. In a second example, an arbitrary location within a relatively thick member is more extensively surrounded on all three axes by foamed epoxy material, and thus by forming bubbles. Because this increases the likelihood of establishing a needed extent of porosity, the above parameters may be adjusted to reduce pore size and profusion in comparison to values suitable for a thin-wall structure, while maintaining adequate cryogenic performance.

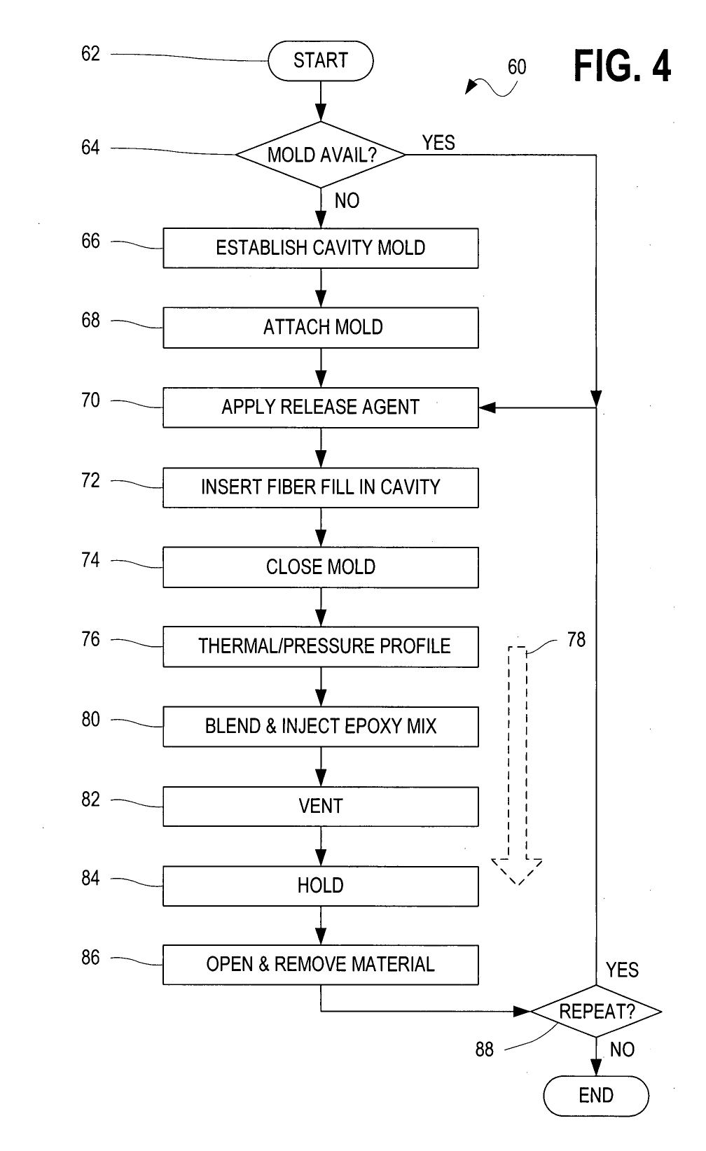

FIG. 4 is a process flow chart 60 that shows the steps for producing an insulating structural material suitable for use in cryogenic environments that may be evacuated or may include immersion in liquid nitrogen, subjection to strong EM fields, or the like, in accordance with an embodiment of the instant invention. After process initialization, step 62, a determination is made whether a mold is available, step 64. If a determination is made that a mold is not available, a mold is established, with a cavity sized and shaped for the desired output, step 66. The output may be, for example, a block of semifinished material, a structural fitting in final shape, or another form. If a determination is made that a mold is available, the process may advance to step 70 described below. Details of mold development may include providing relief angles for product removal, providing inserts such as extractable pins in lieu of drilling holes, allowing inclusion of preformed parts for comolding, choosing a number of mold parts (FIG. 3 shows a three-part mold, for example), establishing a sealing method for the mold, and the like.

The mold is then attached to such input feeds, output vents, and pressure and temperature control apparatus as selected for the process, step 68 (FIG. 2 shows one feed port 30, two vent ports 32, a pressure source 36, and a thermal regulator 42).

Once a configuration is established and the mold is prepared for a next use, a release agent may be applied to surfaces of the cavity, step 70. As noted above, this step may be omitted if no release agent is required or if the release agent is of a type that, blended into the epoxy, migrates to the cavity walls without leaving residues that render the finished material unsuitable for cryogenic applications.

A fibrous fill material is then prepared and inserted within the mold cavity, step 72; for some embodiments, layers of mat material may be cut to a desired size and stacked within the mold, while for other embodiments, a single thick mat or a mass of loose fibers may be placed within the mold cavity. As noted above, this may be performed by blending the fibers into the epoxy and injecting the fibers along with the liquid constituents.

The mold is then closed, step 74, which, in at least some embodiments, includes compressing the fiber material to about half of its relaxed height. As a result of this step, the mold has been placed in a sealed condition, including leak-free positioning of any inserts.

Thermal and pressure conditioning is then performed, step 76. For some embodiments this step may be omitted. For others, displacement of air with dry nitrogen, an extended cold soak, a prolonged hard-vacuum cycle to extract residual adsorbed gases, unpolymerized fiber residues, and other contaminants, or another conditioning process may be applied before injection. Regulation of pressure and temperature may continue, step 78, throughout succeeding process steps, following a profile to regulate process parameters and achieve specific final properties.

A preparation of epoxy and a blowing agent is blended and injected into the mold cavity, step 80. As noted above, this step may take place in parallel with or in sequence with the environmental conditioning of the fiber-filled and closed mold.

The blending-and-injecting process, step 80, may be time- and process-critical in some embodiments. Typical two-part epoxies use a resin (monomer, first precursor, or the like) and a hardener (polymerizer, second precursor, or the like) that may have extended storage lives before combining and short “pot lives” afterward until they are too fully polymerized to flow or to adhere to other materials. Typical blowing agents, likewise, may begin to react promptly when blended into the epoxy, or may respond by other mechanisms to complete their gas-release function.

In other embodiments, as noted above, some aspects of the blending and injecting process, step 80, may be obviated. For example, the fibers may be coated with a blended but unpolymerized epoxy, with polymerization triggered by heat, radiation, or the like. The blowing agent may likewise be triggered to initiate gas formation by a mechanism other than the presence of a constituent of the blended epoxy. The blending sequence could itself affect the process, such as if the blowing agent trigger is a constituent of the hardener, so that the resin and blowing agent may be blended in advance. The hardener might then be admixed during injection, or might take the form of a coating on the fibers, for example.

In some embodiments, the injection process of step 80 may be urged, such as by nitrogen gas under pressure or a mechanical impeller, while in others, a previously-established vacuum may draw the blended material into the mold cavity, wetting substantially all of the fibers and reaching the vent ports by filling the void established by evacuation. These mechanisms are comparable, as each uses a pressure differential to promote mold filling, although the apparatus used may be substantially different.

In some embodiments, a conditioning agent may be incorporated in the injected blend. Conditioning agents are materials that promote wetting, lower blend viscosity at a temperature, slow or accelerate curing or gas formation, or otherwise influence the process or product.

Excess blowing agent gas may be vented, step 82, in some embodiments, and regulated back pressure at the vent port or ports may aid in distribution of the epoxy blend throughout the mold cavity. In some embodiments, residual air or a purging gas may occupy the mold prior to injection, and may be vented during injection and/or curing. In some embodiments, a front wave of the solidifying epoxy arriving at the vents may form a plug restricting venting flow and retaining pressure to an extent that may be controllable by varying mix ingredients.

Holding, step 84—that is, waiting for an interval of time after the above processes and before opening the mold—during which time curing reaches a preferred extent, may continue a temperature and pressure profile as discussed in step 78 in accordance with parameters established for the materials. For example, exothermic epoxy curing may require removing heat during a portion of the processing cycle to regulate curing rate, reduce development of residual stresses, or adjust gas-law-controlled pore formation in view of material wall thickness. The temperature and pressure regulating profile discussed in step 78 may also include such post-cure processes as heating or evacuation, for example, to remove residual gas, unpolymerized resin, and the like while the mold is still sealed.

Mold disassembly and cryogenic structural material removal, step 86, may conclude the process in some embodiments. In others, post-removal processes may include baking to promote further curing, surface preparation by chemical treatment or abrading, cutting components from the as-molded material, overmolding with a second epoxy or other material to fill the pores formed during the above process, testing of specimens, cleaning and reconditioning the mold, and the like. A determination may be made to repeat the process, step 88.

The many features and advantages of the invention are apparent from the detailed specification; thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A porous structural material for immersion in a dielectric cryogenic fluid, comprising:
a matrix of fibers comprising a first organic polymer, wherein the fibers are compatible with being subjected to power transmission field gradients in a cryogenic environment;
an epoxy that wets the fiber matrix substantially completely, and that forms a second organic polymer in the course of a curing process, wherein the epoxy is compatible with being subjected to power transmission field gradients in a cryogenic environment; and
an interconnected pore structure within the epoxy, wherein a blowing agent establishes the pore structure within the epoxy-wetted fiber matrix as a part of the curing process, and wherein the pore structure allows a specified extent of flow of a cryogenic fluid through a porous composite cryogenic structural material established by the curing process.

2. The structural material of claim 1, wherein the matrix of fibers comprises polyester, aramid, polyamide, polyethylene terephthalate, polyphenylene sulfide, liquid crystal polymers, or acrylic, or any combination thereof.

3. The structural material of claim 1, wherein the fiber matrix further comprises at least one discrete layer of nonwoven, generally randomly oriented fibers.

4. The structural material of claim 3, wherein the fibers of the at least one discrete layer are bonded.

5. The structural material of claim 3, wherein the fibers of the at least one discrete layer are bonded by felting, pressure bonding, thermal bonding, chemical bonding, ionizing radiation bonding, or linking during polymerization, or a combination thereof.

6. The structural material of claim 1, wherein the fiber matrix further comprises a plurality of discrete layers of woven fibers.

7. The structural material of claim 1, wherein the fiber matrix further comprises a substantially undifferentiated mass of generally randomly oriented nonwoven fibers.

8. The structural material of claim 1, wherein the fiber matrix of the cured structural material further comprises nonwoven fibers introduced into the epoxy as filler.

9. The structural material of claim 1, wherein the fiber matrix further comprises a combination of a first mass of fibers, introduced into a mold having a plurality of enclosing elements configured to permit assembly to form a closed chamber, and a second mass of fibers, blended into the epoxy prior to injection of the epoxy into the mold.

10. The structural material of claim 1, wherein the epoxy further comprises a mixture of a resin and a reactive hardener that polymerizes the resin under specified environmental conditions.

11. The structural material of claim 1, wherein the blowing agent further comprises a material that reacts at least in part within the matrix of fibers to evolve a gas that forms a plurality of cells within the epoxy, wherein the gas permits joining of the cells to form the interconnected pore structure.

12. The structural material of claim 1, wherein the dielectric constant of the cured structural material is selected to be roughly equal to the dielectric constant of a cryogenic transformer dielectric fill fluid.

13. The structural material of claim 1, wherein an openable mold having at least two constituent parts jointly defining a molded volume when closed, and wherein at least two constituent parts of the mold having respective surfaces generally facing when closed, receives a fiber matrix having an uncompressed height dimension roughly twice a spacing dimension between the facing surfaces of the closed mold.

14. The structural material of claim 1, wherein the volume concentration of epoxy in the cured material is in a range from 50% to 70%, wherein the volume concentration of fibers comprising the fiber matrix in the cured material is in a range from 15% to 30%, and wherein the volume concentration of pores in the cured material is in a range from 15% to 30%, with reference to the volume of a mold wherein the material is cured.

15. The structural material of claim 1, wherein the volume concentration of epoxy in the cured material is about 60%, wherein the volume concentration of fibers comprising the fiber matrix in the cured material is about 20%, and wherein the volume concentration of pores in the cured material is about 20%, with reference to the volume of a mold wherein the material is cured.

16. The structural material of claim 1, wherein parameters of uncured epoxy mixture viscosity, epoxy curing rate, proportion of blowing agent, blowing agent reaction rate, and pressure within the mold are selected and controlled to regulate a size, a profusion, or an extent of linking of pores formed by evolution of gas from the blowing agent, whereby structural material porosity is inversely related to at least one spatial dimension of the structural material.

17. Apparatus for producing porous structural material for immersion in a dielectric cryogenic fluid, comprising:
a mold having a mold cavity configured to constrain constituents to a defined shape during formation of a cryogenic structural component;
at least one mold inlet port configured to admit a hardenable fluid constituent, comprising a blowing agent, into the mold cavity, wherein the hardenable fluid constituent is compatible with exposure to cryogenic fluids and temperatures after hardening;
injection apparatus configured to urge the hardenable fluid constituent into the mold cavity;
at least one mold outlet port configured to vent the mold cavity during filling the mold cavity with the hardenable fluid constituent, forming interconnected pores within the hardenable fluid constituent by a blowing gas released from the blowing agent, or curing of the hardenable fluid constituent at least in part within the mold; and
an environment regulator configured to provide a specified extent of control over temperature or pressure within the mold cavity.

18. The apparatus of claim 17, wherein the mold is configured to accept placement of fiber matrix constituents within the mold cavity prior to mold assembly, and wherein the mold is configured to disassemble sufficiently to remove a component after hardening of the hardenable fluid constituent.

19. A porous structural material for immersion in a dielectric cryogenic fluid, comprising:
means for providing mechanical strength to a cryogenic structural material;
means for binding the means for providing mechanical strength into a solid mass, wherein the means for binding is compatible with exposure to cryogenic environments; and
means for introducing a matrix of interconnected pores within the means for binding.

20. A process of forming a porous structural material for immersion in a dielectric cryogenic fluid, comprising:
placing at least one precut mat of nonwoven fibers within a cavity of a mold;
closing the mold to an extent sufficient to define a specific cavity interior volume and shape and to seal the cavity against uncontrolled outflow of fluids;
injecting an epoxy mixture that includes a blowing agent into the cavity through at least one mold inlet port;
venting gases from the cavity through at least one mold outlet port; and
regulating mold temperature and pressure throughout a cryogenic structural material forming process to an extent sufficient to ensure wetting the fibers, curing the epoxy at least in part, and forming interconnected pores with a specified distribution throughout a cryogenic structural material compatible with immersion and saturation in a cryogenic dielectric fluid.

21. The process of claim 20, further comprising:
coating mold inner surfaces with a mold release agent; and
incorporating a conditioning agent into the uncured epoxy mixture.

22. The process of claim 20, further comprising selecting a combination of constituents and a sequence of process steps that provide a structural material having a net dielectric constant, as immersed and saturated in a cryogenic dielectric fluid, that is approximately equal to the dielectric constant of the cryogenic dielectric fluid alone.
